(19) United States
(12) Patent Application Publication
(10) Pub. No.: US 2020/0113202 A1
(43) Pub. Date: Apr. 16, 2020

(54) FOOD FAT COMPOSITION OF THE MARGARINE TYPE AND METHOD FOR PREPARING IT

(71) Applicant: GEA MECHANICAL EQUIPMENT ITALIA S.P.A., 43123 PARMA (IT)

(72) Inventors: SILVIA GRASSELLI, PARMA (IT); EMANUELE PIZZIGALLI, BERCETO (IT)

(21) Appl. No.: 16/603,885

(22) PCT Filed: Jan. 31, 2018
(86) PCT No.: PCT/IB2018/050594

§ 371 Date: Oct. 9, 2019

(30) Foreign Application Priority Data
Apr. 11, 2017 (IT) 102017000040003

(51) Int. Cl. A23D 7/04; A23D 7/005; A23L 33/21

(52) U.S. Cl. CPC A23D 7/04; A23L 33/21; A23D 7/0056

(57) ABSTRACT

Method for preparing an edible fat composition of the margarine type, comprising the steps of:
preparing an emulsion by mixing 10 parts of food oil of vegetable origin, 7 to 10 parts of aqueous phase and one part of powdered vegetable fibres;
homogenizing the emulsion at a pressure of at least 50 bar;
pasteurizing the emulsion after homogenizing it.

### TECHNICAL FIELD

The present invention relates to a food fat composition of the margarine type and a process for preparing it.

In particular, the invention proposed herein pertains to the dairy sector.

### BACKGROUND ART

Various types of butter are known on the market, i.e. emulsions with a fat phase of animal origin.

Margarines are also known using vegetable fats for the fat phase, such as for example sunflower, soy, palm, peanut, coconut oil, etc.

From patent EP1611794 a “light” margarine type composition and the related production process are also known, for use in doughs suitable to be laminated in puff pastry.

Such margarine comprises a fat phase containing vegetable fats, by weight percentage on the total weight 35 to 80%, an aqueous phase by weight percentage on the total weight 20 to 65% comprising inulin and pectin and at least one emulsifier.

The fat phase consists of interesterified and/or fractionated vegetable oils, in particular palm oil. The emulsifier consists of mono- and diglycerides of dietary fatty acids.

The presence of inulin has the function of improving the absorption and digestion of some minerals, in particular calcium, hence preventing osteoporosis. Furthermore, it is associated with a reduction of the risk of colon cancer and promotes the proliferation of probiotic bacteria in the intestine.

Pectin is instead present as a gelling agent for the composition.

As already mentioned above, the composition described in patent EP1611794 is proposed as a “light” margarine, i.e. with a low fat content, comprising ingredients that consumers perceive as natural and/or beneficial.

However, such composition is not easy to spread when cold. Furthermore, the use of palm oil does not make it appealing to consumers.

### OBJECT OF THE INVENTION

In this context, the technical task underpinning the present invention is to propose a food fat composition of the margarine type having greater viscosity than known solutions, so as to be easily spread also when cold.

Another object of the present invention is to provide a food fat composition of the margarine type that is more stable over time with respect to known solutions, i.e. a composition in which the fat phase and the aqueous phase remain emulsified for a longer period.

Another object of the present invention is to provide a food fat composition of the margarine type that has a further reduced fat content and that uses healthier ingredients with respect to known solutions.

Another object of the present invention is to provide a food fat composition of the margarine type that is suitable for a vegan diet.

Another object of the present invention is to provide a process for preparing a food fat composition of the margarine type, which allows the viscosity, stability and consistency of the composition itself to be increased, without increasing the cost of the recipe.

Another object of the present invention is to provide a process for preparing a food fat composition of the margarine type, which further reduces the fat content.

The defined technical task and the specified objects are substantially reached by a process for preparing a foot fat composition of the margarine type, comprising the steps of:
preparing an emulsion by mixing 10 parts of food oil of vegetable origin, 7 to 10 parts of aqueous phase and one part of powdered vegetable fibres;
homogenizing the emulsion at a pressure of at least 50 bars;
pasteurizing the emulsion.

Preferably, the food oil of vegetable origin is olive oil.

In accordance with one embodiment, the vegetable fibres are derived from Citrus, Solanum tuberosum, Plantago ovatae, Pisum sativum, Ascophyllum nodosum.

Preferably, citric acid or ascorbic acid is also employed in the preparation of the emulsion in order to contrast oxidation.

Preferably, salt and/or yeast extract is also employed in the preparation of the emulsion.

The preparation of the emulsion occurs by mixing the indicated components at a temperature comprised between 20° C. and 45° C. for a time interval of 10-20 minutes.

Preferably, the step of homogenizing the emulsion occurs at a pressure comprised between 70 bar and 150 bar.

The step of homogenizing the emulsion occurs by subjecting the emulsion to a forced passage through a gap obtained between a lower annular chamber and an upper annular chamber of a homogenizing valve.

In particular, such homogenizing valve comprises an annular passage head and an annular impact head interposed between the lower annular chamber and the upper annular chamber. The gap is defined between the annular passage head and the annular impact head.

The pasteurization preferably occurs after the emulsion has been homogenized, and consists in keeping the emulsion at a temperature higher than 60° C. for 10-30 minutes.

The defined technical task and the specified objects are substantially reached by a food fat composition of the margarine type, comprising, by weight percentage on the total weight:
45% to 50% of olive oil;
45% to 50% of aqueous phase;
4% to 5% of vegetable fibres.

In accordance with one embodiment, the vegetable fibres are derived from Citrus, Solanum tuberosum, Plantago ovata, Pisum sativum, Ascophyllum nodosum.

Preferably, the composition also comprises:
0.001% to 0.003% of citric acid, expressed by weight percentage on the total weight, or
0.01% to 0.03% of ascorbic acid, expressed by weight percentage on the total weight.

Preferably, the composition also comprises:
0.5% to 1% of salt, expressed by weight percentage on the total weight, and/or
0.25% to 0.5% of yeast extract, expressed by weight percentage on the total weight.

### BRIEF DESCRIPTION OF THE DRAWINGS

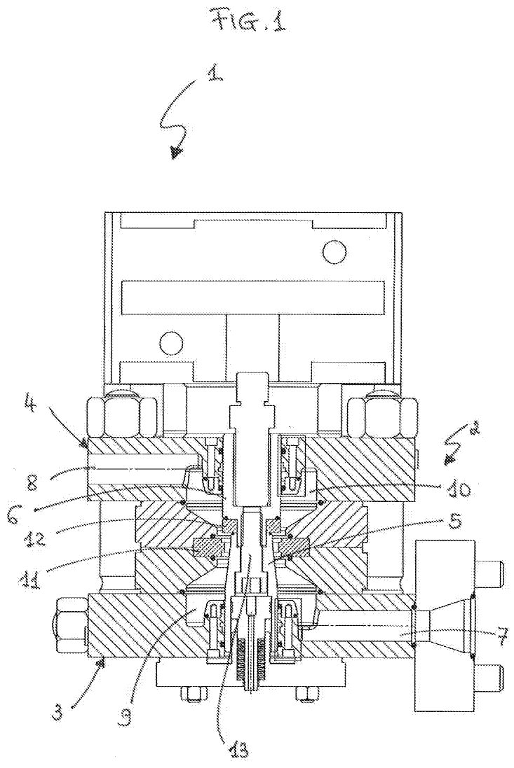

Further characteristics and advantages of the present invention will become more apparent from the following indicative, and hence non-limiting, description of a preferred, but not exclusive, embodiment of a food fat composition of the margarine type and a process for preparing it, wherein the homogenization step is performed in a homogenizing valve illustrated in FIG. 1, in a sectional view.

### DETAILED DESCRIPTION OF PREFERRED EMBODIMENTS OF THE INVENTION

The process for preparing a food fat composition of the margarine type comprises the steps of:
preparing an emulsion by mixing 10 parts of edible oil of vegetable origin, 7 to 10 parts of aqueous phase and one part of powdered vegetable fibres;
homogenizing the emulsion at a pressure of at least 50 bar;
pasteurizing the emulsion.

In the embodiment described and illustrated herein, the food oil of vegetable origin is olive oil.

Alternatively, soya seed oil or sunflower seed oil can be employed.

In particular, the emulsion is prepared at a temperature comprised between 20° C. and 45° C. for a time interval of 10-20 minutes.

Preferably, the emulsion is prepared by mixing 10 parts of olive oil, 10 parts of aqueous phase and one part of powdered vegetable fibres. The use of 10 parts of aqueous phase allows the compactness of the composition to be increased. Instead, if 7 parts of aqueous phase are used, the final composition is less compact, but still better in terms of viscosity and compactness with respect to known solutions.

Preferably, the vegetable fibres used are derived from Citrus, Solanum tuberosum, Plantago ovata, Pisum sativum, Ascophyllum nodosum.

In particular, in the experimental tests discussed below, a commercial product known as Hi-Fiber WF by HI-FOOD S.p.A. with registered office in Viale Mentana 150, 43121 Parma, Italy, is used.

In the preparation of the emulsion, citric acid or ascorbic acid can also be employed. The function of such components is to contrast the oxidation of the final composition.

In the preparation of the emulsion it is also possible to employ salt or other flavourings or aromas.

For example, in the experimental tests discussed below, a commercial product is used, known as Hi-Booster NT04 by the company HI-FOOD S.p.A. The product Hi-Booster NT04 is a yeast extract or flavour enhancer. Preferably, the homogenization occurs at a pressure comprised between 70 bar and 150 bar.

Preferably, the pasteurisation step is performed by forcing the emulsion through a gap afforded between a lower annular chamber 9 and an upper annular chamber 10 of a homogenising valve 1.

In the preferred embodiment described and illustrated herein, the homogenising valve 1 comprises a valve body 2 defining a through hole with an axial extension with respect to the valve body 2.

Preferably, the valve body 2 is formed by the assembly of a lower valve body 3 and an upper valve body 4, which are axially aligned.

The valve 1 comprises a lower piston 5, inserted in a first section of the through hole at the lower valve body 3, and an upper piston 6, inserted in a second section of the through hole at the upper valve body 4. The lower piston 5 and the upper piston 6 are integrally coupled.

The valve 1 has an inlet 7 at high pressure for the emulsion and an outlet 8 at low pressure for the homogenized emulsion. The inlet 7 can be connected to a high pressure pump (not shown).

Between the valve body 2 and the lower piston 5, the lower annular chamber 9 is obtained, into which the inlet 7 at high pressure opens.

Between the valve body 2 and the upper piston 6, the upper annular chamber 10 is obtained, into which the outlet 8 opens. In particular, the upper annular chamber 10 transfers the homogenized emulsion at low pressure to the outlet 8 of the valve 1.

The valve 1 comprises an annular passage head 11 and an annular impact head 12, which have axial symmetry and are interposed between the lower annular chamber 9 and the upper annular chamber 10.

The passage head 11 is integrally constrained to the valve body 2.

The impact head 12 is integrally coupled to the lower piston 5 and to the upper piston 6 so as to form an assembled member. For example, the coupling is performed by means of a screw 13, which is part of the assembled organ.

The valve 1 is provided with means for moving the assembled organ in the axial direction towards the annular passage head 11 so that the impact head 12 defines with the passage head 11 a gap for the passage of the emulsion from the lower annular chamber 9 to the upper annular chamber 10.

In particular, the movement of the assembled member towards the passage head 11 contrasts the pressure exerted by the fluid contained in the lower annular chamber 9 on the impact head 12.

After homogenization, the pasteurization step occurs, which consists in keeping the homogenized emulsion at a temperature higher than 60° C. for 10-30 minutes.

Further details on the pasteurization step will not be provided since the pasteurization takes place according to the prior art and is not the subject matter of the present invention.

The food fat composition thus obtained comprises the following ingredients, expressed as weight percentage on the total weight:
45% to 50% of olive oil;
45% to 50% of aqueous phase;
4% to 5% of vegetable fibres.

In a preferred embodiment, the composition further comprises 0.001% to 0.003% of citric acid, expressed by weight percentage on the total weight.

Alternatively to citric acid, the composition comprises 0.01% to 0.03% of ascorbic acid, expressed by weight percentage on the total weight.

Furthermore, the composition may comprise, as weight percentage on the total weight:
0.5% to 1% of salt, and/or
0.25% to 0.5% of Hi-Booster NT04.

The process just described allows a food fat composition of the margarine type to be obtained, having greater stability, higher viscosity and a reduced fat content with respect to known solutions. The composition obtained is also easy to spread when cold, creamy and free from lumps, i.e. smooth and homogeneous.

Such properties have been demonstrated through some laboratory tests, described below. The tests were performed in association with the Department of Food Science and Pharmacy at the University of Parma.

In a first test, the viscosity of the following products was compared:

A—emulsion prepared by mixing 10 parts of olive oil, 10 parts of aqueous phase, one part of Hi-Fiber WF and 0.7 g of citric acid, pasteurized at about 73° C. for about 30 minutes;

B—emulsion prepared by mixing 10 parts of olive oil, 10 parts of aqueous phase, one part of Hi-Fiber WF and 0.7 g of citric acid; homogenized at 70 bar and pasteurized at about 73° C. for about 30 minutes;

C—emulsion prepared by mixing 10 parts of olive oil, 10 parts of aqueous phase, one part of Hi-Fiber WF and 0.7 g of citric acid; homogenized at 100 bar and pasteurized at about 73° C. for about 30 minutes;

D—emulsion prepared by mixing 10 parts of olive oil, 10 parts of aqueous phase, one part of Hi-Fiber WF and 0.7 g of citric acid; homogenized at 150 bar and pasteurized at about 72° C. for about 30 minutes.

For each sample the hardness, expressed in N, was measured, which was taken as an index of compactness and spreadability.

Mean and standard deviation values are shown in the table below, both at the end of the composition production process, and after a 35-day break.

| | Hardness (N) measured at the | Hardness (N) measured |
|---|---|---|
| Sample | end of the production process | after 35 days |
| A | 0.14 ± 0.01 | 0.15 ± 0.01 |
| B | 0.18 ± 0.01 | 0.20 ± 0.01 |
| C | 0.17 ± 0.01 | 0.20 ± 0.01 |
| D | 0.16 ± 0.01 | 0.18 ± 0.01 |

Below there is a table showing the hardness values recorded for samples A and C over a 56-day break at 4° C. (second test).

| Break days at 4° C. | A | C |
|---|---|---|
| 1 | 0.30 ± 0.02 | 0.42 ± 0.01 |
| 7 | 0.27 ± 0.01 | 0.41 ± 0.01 |
| 14 | 0.28 ± 0.02 | 0.41 ± 0.01 |
| 21 | 0.28 ± 0.01 | 0.35 ± 0.02 |
| 28 | 0.36 ± 0.04 | 0.35 ± 0.01 |
| 35 | 0.51 ± 0.04 | 0.32 ± 0.01 |
| 42 | 0.58 ± 0.02 | 0.37 ± 0.01 |
| 56 | 0.38 ± 0.03 | 0.35 ± 0.01 |

Below there is a table showing the hardness values recorded for samples A and C over a 56-day break at 25° C. (third test).

| Break days at 25° C. | A | C |
|---|---|---|
| 1 | 0.24 ± 0.01 | 0.37 ± 0.02 |
| 7 | 0.22 ± 0.01 | 0.35 ± 0.01 |
| 14 | 0.19 ± 0.01 | 0.31 ± 0.01 |
| 21 | 0.23 ± 0.01 | 0.31 ± 0.02 |
| 28 | 0.23 ± 0.01 | 0.31 ± 0.01 |
| 35 | 0.23 ± 0.01 | 0.31 ± 0.01 |
| 42 | 0.22 ± 0.01 | 0.30 ± 0.01 |
| 56 | 0.18 ± 0.02 | 0.28 ± 0.00 |

From the values reported above, it can be deduced that the homogenization makes the hardness increase. However, even if the homogenized samples are harder than the non-homogenized ones, the measurements also indicate that the hardness has less time variability for the homogenized samples with respect to the non-homogenized samples.

It can therefore be deduced that the homogenized samples are more spreadable and creamy over the long term with respect to the non-homogenized samples, whose hardness tends to increase as the days pass.

The best behaviour, both in terms of compactness and stability, is shown by sample C (homogenization at 100 bar).

Hi-Fiber WF, premixed with the aqueous phase and olive oil in the ratios indicated above, is able to produce an emulsion that already has a high level of stability with respect to other known solutions, but whose stability is further increased by homogenization at 100 bar.

In particular, sample A after a 56-day break, separates into its fat and aqueous phases.

Homogenization at 100 bar instead allows sample C to maintain its stability even after a 56-day break, i.e. the fat phase and the aqueous phase remain emulsified (they do not separate).

From the tests performed, the characteristics of the food fat composition of the margarine type and the process for preparing it, according to the present invention, are clear, as are the advantages.

In particular, the use of vegetable fibres in the indicated percentage in the preparation of the emulsion and the performance of the homogenization step at low pressure (minimum 50 bar) allow the viscosity, stability and compactness of the composition obtained to be increased and the fat content to be reduced. In fact, if 100 grams of butter have a calorie content of over 700 Kcal, 100 grams of the composition proposed herein have a calorie content of about 430 Kcal.

The composition thus obtained is compact but easy to spread, even when cold, smooth and homogeneous (i.e. free from lumps).

Furthermore, the use of an annular double chamber valve for homogenizing the emulsion, allows work to be performed at relatively low homogenization pressures (up to 50 bar), hence avoiding any increase in energy consumption.

Also the cost of the recipe is contained since there are substantially three ingredients: aqueous phase, fat phase (olive oil) and vegetable fibres, possibly with the addition of salt and/or aromas and citric or ascorbic acid. The composition is also suitable for a vegan diet.

1-17. (canceled)

18. Method for preparing a food fat composition of the margarine type, comprising the steps of:
preparing an emulsion by mixing 10 parts of food oil of vegetable origin, 7 to 10 parts of aqueous phase and one part of powdered vegetable fibres;
homogenizing said emulsion at a pressure of at least 50 bars by subjecting the emulsion to a forced passage through a gap obtained between a lower annular chamber (9) and an upper annular chamber (10) of a homogenizing valve (1), said homogenizing valve (1) comprising an annular passage head (11) and an annular impact head (12) interposed between said lower annular chamber (9) and said upper annular chamber (10), said gap being defined between the annular passage head (11) and the annular impact head (12);
pasteurizing said emulsion.

19. Method according to claim 18, wherein the food oil of vegetable origin is olive oil.

20. Method according to claim 18, wherein the step of homogenizing said emulsion occurs at a pressure between 70 bars and 150 bars.

21. Method according to claim 18, wherein said step of pasteurizing the emulsion occurs after the step of homogenising, said step of pasteurizing consisting in keeping said emulsion at a temperature higher than 60° C. for 10-30 minutes.

22. Method according to claim 18, wherein said vegetable fibres are derived from Citrus, Solanum tuberosum, Plantago ovata, Pisum sativum, Ascophyllum nodosum.

23. Method according to claim 18, wherein citric acid or ascorbic acid is also employed in the preparation of said emulsion to counteract oxidation.

24. Method according to claim 18, wherein also salt is employed in the preparation of said emulsion.

25. Method according to claim 18, wherein also a yeast extract is employed in the preparation of said emulsion.

26. Method according to claim 18, wherein the step of preparing an emulsion occurs at a temperature between 20° C. and 45° C. for a time interval of 10-20 minutes.

27. Food fat composition of the margarine type obtained by the method according to claim 18, said food fat composition comprising by weight percentage on the total weight:
45% to 50% of olive oil;
45% to 50% of aqueous phase;
4% to 5% of vegetable fibres.

28. Food fat composition according to claim 27, wherein said vegetable fibres are derived from Citrus, Solanum tuberosum, Plantago ovata, Pisum sativum, Ascophyllum nodosum.

29. Food fat composition according to claim 27, comprising also 0.001% to 0.003% of citric acid, expressed as weight percentage on the total weight.

30. Food fat composition according to claim 27, comprising also 0.01% to 0.03% of ascorbic acid, expressed as weight percentage on the total weight.

31. Food fat composition according to claim 27, comprising also 0.5% to 1% of salt, expressed as weight percentage on the total weight.

32. Food fat composition according to claim 27, comprising also 0.25% to 0.5% of a yeast extract, expressed as weight percentage on the total weight.
